(19) United States
(12) Patent Application Publication
(10) Pub. No.: US 2012/0147985 A1
(43) Pub. Date: Jun. 14, 2012

(54) FEEDBACKING CHANNEL INFORMATION IN WIRELESS COMMUNICATION SYSTEM

(75) Inventors: Jianjun Li, Seoul (KR); Kyoungmin Park, Goyang-si (KR); Sungjin Suh, Seoul (KR); Myungcheul Jung, Seoul (KR)

(73) Assignee: PANTECH CO., LTD., Seoul (KR)

(21) Appl. No.: 13/390,868

(22) PCT Filed: Aug. 18, 2009
(86) PCT No.: PCT/KR2009/004606

§ 371 Date: Feb. 16, 2012

(51) Int. Cl. H04B 15/00; H04W 72/04

(52) U.S. Cl. 375/285

(57) ABSTRACT

The present invention relates to feedback channel information in wireless communication system.

### CROSS-REFERENCE TO RELATED APPLICATION

This application is the National Stage Entry of International Application PCT/KR2009/004606, filed on Aug. 18, 2009, which is incorporated herein by reference for all purposes as if fully set forth herein.

### BACKGROUND

1. Field

The present invention relates to feedback channel information in wireless communication system

2. Discussion of the Background

There are a number of multi-antenna transmission schemes or transmission such as transit diversity, closed-loop spatial multiplexing or open-loop spatial multiplexing. Closed-loop MIMO (CL-MIMO) relies on more extensive feedback from the mobile terminal.

### SUMMARY

In accordance with an aspect, there is provided method for feedbacking channel information for the mobile terminal, the method comprising: estimating a downlink channel from the received signal; selecting one matrix in the codebook based on the estimated channel state information wherein the codebook has the property to support differential PMI feedback; and feedbacking the differential value of the PMI (Precoding Matrix Index) of the selected matrix and the previous feedback PMI to the base station.

In accordance with another aspect, there is provided a mobile terminal comprising: An estimator configured to estimate a downlink channel from a received signal, select one matrix in the codebook based on the estimated channel state information, check whether it is in differential PMI (Precoding Matrix Index) feedback mode, feedbacking the differential value of the PMI of the selected matrix and the previous feedback PMI to the base station if it is in differential PMI feedback mode (Y) and feedback this PMI to the base station If it is not in differential PMI feedback mode (N); and a post-decoder configured to process the received signal and decode the precoded symbol.

In accordance with a further aspect, there is provided a base station comprising: a layer mapper configured to configured to map one or two codewords to the layers; and a precoder configured to receive the differential value of the PMI compared with previous feedback PMI and add the differential PMI to the previous feedback PMI to get the updated PMI, and precode the symbols from the layer mapper using a precoding matrix derived from the updated PMI.

### BRIEF DESCRIPTION OF THE DRAWINGS

FIG. 1 is the block diagram of the wireless communication system using closed-loop spatial multiplexing according to one embodiment.

FIG. 2 is the flowchart of the original codebook based feedback according to other embodiment.

FIG. 3 is the flowchart of the differential PMI based feedback according to another embodiment.

FIG. 4 is the flowchart of index reorder for code generation according to further another embodiment.

### DETAILED DESCRIPTION OF THE ILLUSTRATED EMBODIMENTS

Hereinafter, embodiments of the present invention will be described in detail with reference to the attached drawings.

There are a number of multi-antenna transmission schemes or transmission such as transit diversity, closed-loop spatial multiplexing or open-loop spatial multiplexing. Closed-loop MIMO (CL-MIMO) relies on more extensive feedback from the mobile terminal.

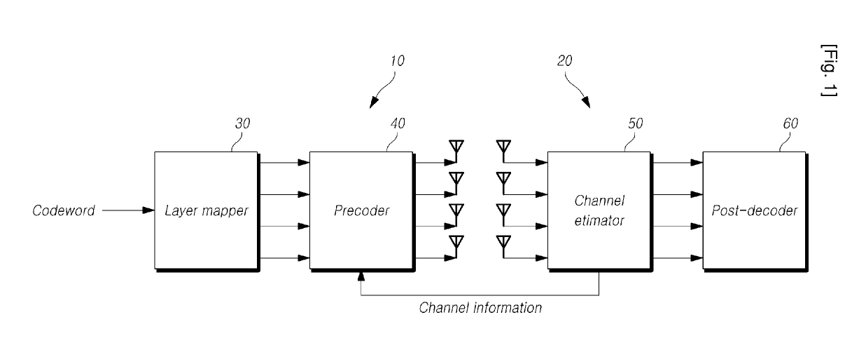

FIG. 1 is the block diagram of the wireless communication system using closed-loop spatial multiplexing according to one embodiment.

Referring to FIG. 1, the wireless communication system using closed-loop spatial multiplexing according to one embodiment comprises a transmitter (10) and a receiver (20). The transmitter (10) may be a base station and the receiver (20) may be a mobile terminal and the reverse.

The transmitter (10) comprises a layer mapper (30) and a precoder (40). The receiver (20) comprises a channel estimator (50) and a post-decoder (60).

The layer mapper (30) of the transmitted 10) maps One or two codewords, corresponding to one or two transport, to the layers N_{L} which may range from a minimum of one layer up to a maximum number of layers equal to the number of antenna ports. In case of multi-antenna transmission, there can be up to two transport blocks of dynamic size for each TTI. Where each transport block corresponds to one codeword in case of downlink spatial multiplexing. In other words, the block of modulation symbols (one block per each transport block) refers to as a codeword.

After layer mapping by the layer mapper (30), a set of N_{L} symbols (one symbol from each layer) is linearly combined and mapped to the N_{A} antenna port by the precoder (40). This combining/mapping can be described by means of a precoding matrix W of size N_{L} N_{A}. In case of spatial multiplexing, the number of layers is also referred to as the transmission rank.

To assist the base station in selecting a suitable precoding matrix W for transmission by the transmitted 10), the mobile terminal may report channel information such as a recommended number of layers (expressed as a Rank Indication, RI) or a recommended precoding matrix (Precoding Matrix Index, PMI) corresponding to that number of layers, depending on estimates of the downlink channel conditions.

The channel estimator (50) of the receiver (20 estimates the downlink channel condition. The channel estimator (50) feedbacks at least one of RI and PMI to the transmitted 10). The channel estimator (50) may perform many kinds of codebook based PMI feedback.

The post-decoder (50) processes the received signal and decodes the precoded symbol.

There is codebook based PMI feedback where the mobile terminal (10) feedbacks the precoding matrix index (PMI) of the favorite matrix in the codebook to the base station (10) to support CL-MIMO (closed MDVIO) operation in wireless communication system.

Based on this feedback, the base station (10) can decide the precoding matrix.

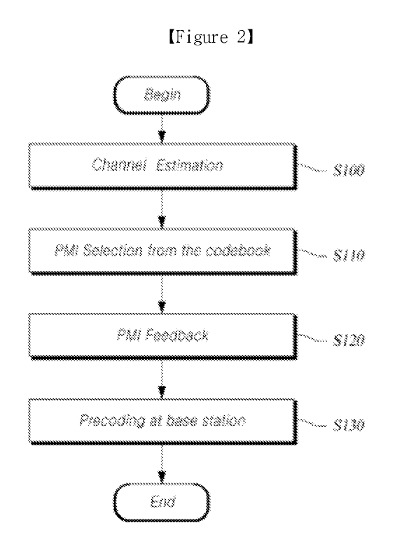

FIG. 2 is the flowchart of the original codebook based feedback according to other embodiment.

Referring to FIG. 2, in the original codebook based feedback, firstly the mobile terminal (10) estimate the channel (S100). Based on the estimated channel state information, the mobile terminal (10) selects the favorite matrix in the codebook (S110) as follows.

1) For precoding based codebook feedback, based on the estimated channel, the mobile terminal (10) computes the channel state information such as the sum rate or SINR for all matrices in the codebook and select the matrix which has the highest sum rate or SINR. In this case the sum rate may mean the total transmit data rate by all the transmit antennas. With different precoding matrix, the transmit data rate is different. So we select the matrix from the codebook that makes sum rate maximum.

2) For CSI based codebook feedback, the codebook is designed for channel feedback. In this case, based on the estimated channel, the mobile terminal (10) computes the distance between the channel and all matrices in the codebook and selects the matrix which is most similar to the channel matrix, that is, the smallest distance.

One of the popular distance between Matrix for codebook design may be, not limited, Chordal distance. The definition of Chordal distance is as follows:

$$d ( H , C ) = \frac{1}{\sqrt{2}} \vert {HH}^{*} - {CC}^{*} \vert \qquad [ Math Figure 1 ]$$

Wherein H is the channel matrix and C is the matrix in the codebook, H* and C* is the cojugate of H and C.

Once the favorite matrix is decided, the mobile terminal (10) feedbacks the PMI of the selected matrix to the base station (10) (S120).

At the base station (10), for precoding based codebook feedback, it directly uses this matrix as the precoding matrix. For CSI based codebook feedback, it takes this matrix as the channel matrix to derive the precoding matrix by SVD (Singular Value Decomposition) or others algorithms. Finally the base station (10) precodes the modulated symbols by using this matrix for multiple antennas (S130).

For the codebook based feedback, the feedback overhead depends on the codebook size. Usually for 4Tx and 8Tx codebook, the size is as big as 64, so that 6 bit feedback is needed which lead to higher overhead. If we reduce the codebook size for small overhead, the performance will be decreased a lot. It is better to consider other way to reduce the feedback overhead.

In this embodiment, it is proposed differential PMI feedback scheme to reduce the overhead. In the proposed scheme, for low and middle mobility, the mobile terminal (10) compares the PMI of the selected matrix and the previous feedback PMI and only feedbacks 1 or 2 bits differential value of these two PMIs to the base station (10). The feedback overhead is greatly reduced.

In order to support differential PMI feedback, the codebook should have special feature. If the codebook does not have this feature, an index reorder scheme is proposed to make it work. It is obviously that the differential PMI feedback together with the index reorder scheme can greatly reduce the feedback overhead.

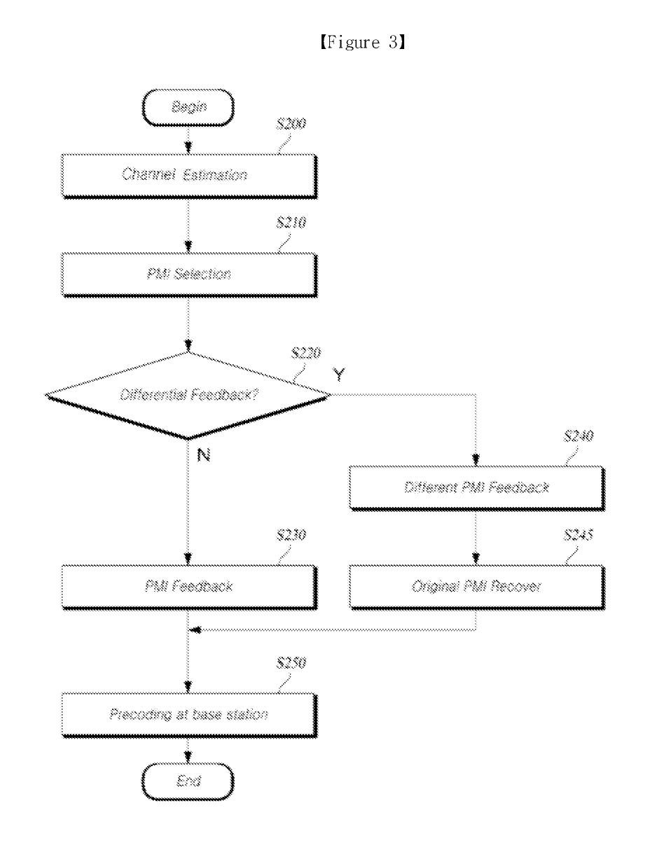

FIG. 3 is the flowchart of the differential PMI based feedback according to another embodiment.

In low and middle mobility, the channel does not change a lot from frame to frame so that the selected matrix from the codebook for feedback also does not change a lot. If we design the codebook properly, that is, similar matrix has the nearby index, then the feedback PMI also does not change a lot from frame to frame. In this case, it can be considered to use the differential PMI feedback.

Referring to FIG. 3, in the differential PMI feedback, firstly the mobile terminal (10) estimates the channel (S200). Based on the estimated channel state information, the mobile terminal (10) selects the favorite matrix in the codebook (S210) as follows.

1) For precoding based codebook feedback, based on the estimated channel, the mobile terminal (10) computes the sum rate or SINR information for all matrices in the codebook and select the matrix which has the highest sum rate or SINR.

2) For CSI based codebook feedback, the codebook is designed for channel feedback. In this case, based on the estimated channel, the mobile terminal (10) computes the distance between the channel and all matrices in the codebook and selects the matrix which is most similar to the channel matrix, that is, the smallest distance.

Once the favorite matrix is decided, the mobile terminal (10) will check whether it is in differential PMI feedback mode (S220). In other words, the mobile terminal (10) need check the mode for feedback which is decided by the base station (10) at this step S220.

Usually the base station (10) takes the following factor into account to decide the mode.

1) For the first feedback, it can not be in the differential PMI feedback mode.

2) For high mobility or performance requirement, it is better in base mode (original PMI feedback mode).

3) Periodically the base mode is used to remove the accumulated error by differential PMI feedback. That is, for every N frames (for example 1000 frames), the base station (10) asks the mobile terminal (10) to perform original PMI feedback, not differential PMI feedback.

If it is not in differential PMI feedback mode (N), the mobile terminal (10) will directly feedback this PMI to the base station (10) (S230). If it is in differential PMI feedback mode (Y), the mobile terminal (10) compares the PMI of the selected matrix and the previous feedback PMI and feedbacks the differential value of these two PMIs to the base station (10) (S240). If the mobility is not high, the differential value is small. 1 or 2 bits for differential PMI is enough so that the feedback overhead is greatly reduced.

In original PMI feedback, the base station (10) can get the feedback PMI directly. However, in differential PMI feedback, the mobile terminal (10) only feedbacks the differential value of the PMI compared with previous feedback PMI. In order to get the original PMI, at the base station (10), it needs to add the differential PMI to the previous PMI to get the updated PMI for precoding (S245).

At the base station (10), once it gets the PMI from the mobile terminal (10) for precoding based codebook feedback, it directly uses this matrix as the precoding matrix. For CSI based codebook feedback, it takes this matrix as the channel matrix to derive the precoding matrix by SVD or others algorithms.

Finally the base station (10) precodes the modulated symbols by using of this matrix for multiple antennas (S250) by means of the precoder (40) as shown in FIG. 1.

There is example by codebook size 64 to show that for low mobility, differential PMI feedback can reduce the feedback overhead.

TABLE 1

| | Frame ID | | | | | | | | |
|---|---|---|---|---|---|---|---|---|---|
| | 1 | 2 | 3 | 4 | 5 | 6 | 7 | 8 | 9 |
| PMI | 36 | 37 | 38 | 39 | 38 | 37 | 36 | 35 | 36 |
| (bits) | (6) | (6) | (6) | (6) | (6) | (6) | (6) | (6) | (6) |
| Differ- | 36 | 1 | 1 | 1 | −1 | −1 | −1 | −1 | 1 |
| ential | (6) | (1) | (1) | (1) | (1) | (1) | (1) | (1) | (1) |
| PMI | | | | | | | | | |
| (bits) | | | | | | | | | |

Referring to the table 1, it can be known that for original PMI feedback, all feedbacks needs 6 bits. However it can be known that for differential PMI feedback, only the first feedback needs 6 bits. It only needs 1 bit for the later feedbacks after the first one.

In order to use differential PMI feedback, the codebook must has some special feature as follows to make similar matrix have nearby index.

1) The matrices in the codebook with the nearest (or adjacent) index must have the smallest distance. It is better all the distance between matrices with the nearest (or adjacent) index are the same.

2) Cyclic symmetric property, that is, the matrix with the largest index must have the smallest distance with the matrix with smallest index.

It is easy to see that DFT codebook has these kinds of property. As an example, the rank 1 codebook (2 Tx) for differential PMI feedback is shown as follows.

$$\begin{matrix}C = \{ {c}_{0} , {c}_{1} , … , {c}_{7} \} \\ = \{ [ \begin{matrix}1 \\ 1\end{matrix} ] , [ \begin{matrix}1 \\ {e}^{j \frac{π}{4}}\end{matrix} ] , [ \begin{matrix}1 \\ {e}^{j \frac{2 π}{4}}\end{matrix} ] , [ \begin{matrix}1 \\ {e}^{j \frac{3 π}{4}}\end{matrix} ] , [ \begin{matrix}1 \\ {e}^{j \frac{4 π}{4}}\end{matrix} ] , \\ [ \begin{matrix}1 \\ {e}^{j \frac{5 π}{4}}\end{matrix} ] , [ \begin{matrix}1 \\ {e}^{j \frac{6 π}{4}}\end{matrix} ] , [ \begin{matrix}1 \\ {e}^{j \frac{7 π}{4}}\end{matrix} ] \}\end{matrix} \qquad [ Math Figure 2 ]$$

If the codebook does not has the property to support differential PMI feedback, we can make it work by codebook index reorder.

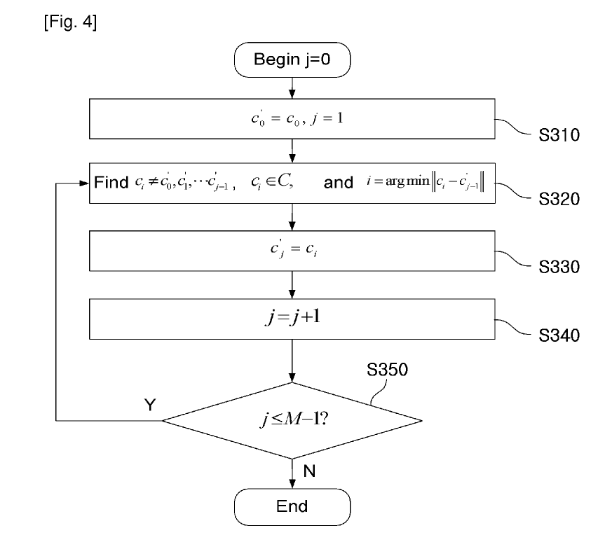

FIG. 4 is the flowchart of index reorder for code generation according to further another embodiment.

If the codebook does not have the above property, we can make it has the similarity by codebook index reorder. The iterative procedure for index reorder can be shown as follows, referring to FIG. 4.
Let us assume C={c₀,c₁, . . . ,c_{M-1}} is the original codebook, C′={c₀′,c₁′, . . . , c_{M-1}′} the codebook after index reorder for

differential PMI feedback.
1. Begin, from the index 0, Let c₀′=c₀ and j=1 (S310).
2. Find cᵢ≠c₀!, and cᵢ∈C, i=arg min∥cᵢ−c₀′∥,
3. Let c₁′=cᵢ,
4. Iteration. Find cᵢ≠c₀′,c₁′, . . . cⱼ₋₁′ and cᵢ∈C, i=arg min∥cᵢ−cⱼ₊₁∥ (S320),
5. Let cⱼ′=cᵢ and j=j+1 (S330, S340).
6. If j≦M−1, go to 4) (S350),
7. If else finish the iteration, and got the new codebook.

After the index reorder, the codebook has the property to support differential PMI feedback.

In case the original LTE codebook

$$C = \{ {c}_{0} , {c}_{1} , {c}_{2} , {c}_{3} \} = \{ \frac{1}{\sqrt{2}} [ \begin{matrix}1 \\ 1\end{matrix} ] , \frac{1}{\sqrt{2}} [ \begin{matrix}1 \\ - 1\end{matrix} ] , \frac{1}{\sqrt{2}} [ \begin{matrix}1 \\ j\end{matrix} ] , \frac{1}{\sqrt{2}} [ \begin{matrix}1 \\ - j\end{matrix} ] \}$$

which is proposed from

the Long Term Evolution (3GPP TS 36.211), the above iterative procedure for index reorder is performed below.
1. At step S310,

$${c}_{0}^{′} = {c}_{0} = \frac{1}{\sqrt{2}} [ \begin{matrix}1 \\ 1\end{matrix} ]$$

and, j=1 (S310)
2. If cᵢ=c₀′, and cᵢ∈C, i=arg min[cᵢ−c₀′∥=2 at the first step S320.

3.

$${c}_{1}^{′} = {c}_{2} = \frac{1}{\sqrt{2}} [ \begin{matrix}1 \\ j\end{matrix} ]$$

at the first step S330.
4. After the first S340 and S350, j=2 and i=arg min∥cᵢ−c₀′∥=1,
5.

$${c}_{2}^{′} = {c}_{1} = \frac{1}{\sqrt{2}} [ \begin{matrix}1 \\ - 1\end{matrix} ]$$

at the second step S330.
6. After the third, iteration of S320 and S330;

$${c}_{s}^{′} = {c}_{s} = \frac{1}{\sqrt{2}} [ \begin{matrix}1 \\ - j\end{matrix} ] , .$$

7. The new index reordered codebook

$$C = \{ \frac{1}{\sqrt{2}} [ \begin{matrix}1 \\ 1\end{matrix} ] , \frac{1}{\sqrt{2}} [ \begin{matrix}1 \\ j\end{matrix} ] , \frac{1}{\sqrt{2}} [ \begin{matrix}1 \\ - 1\end{matrix} ] , \frac{1}{\sqrt{2}} [ \begin{matrix}1 \\ - j\end{matrix} ] \} ..$$

An above example of index reorder codebook design for differential PMI Feedback by LTE rank 1 codebook of 2 TX is described at the following table 2.

TABLE 2

| | | Index |
|---|---|---|
| Codebook | LTE | reordered |
| index | codebook | codebook |
| 0 | $\frac{1}{\sqrt{2}} [ \begin{matrix}1 \\ 1\end{matrix} ]$ | $\frac{1}{\sqrt{2}} [ \begin{matrix}1 \\ 1\end{matrix} ]$ |
| 1 | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ |
| 2 | $\frac{1}{\sqrt{2}} [ \begin{matrix}1 \\ j\end{matrix} ]$ | $\frac{1}{\sqrt{2}} [ \begin{matrix}1 \\ - 1\end{matrix} ]$ |
| 3 | $\frac{1}{\sqrt{2}} [ \begin{matrix}1 \\ - j\end{matrix} ]$ | $\frac{1}{\sqrt{2}} [ \begin{matrix}1 \\ - j\end{matrix} ]$ |

After the index reorder, the LTE codebook will have the property to support differential PMI feedback.

The above embodiment proposes differential PMI feedback scheme to reduce the feedback overhead. In the proposed scheme, for low and middle mobility, the mobile terminal (10) compares the PMI of the selected matrix and the previous feedback PMI and only feedback 1 or 2 bits differential value of these two PMIs to the base station (10). The feedback overhead is greatly reduced.

Although some embodiments are described above, the present invention is not limited thereof.

As an example, there is an above example of index reorder codebook design for differential PMI Feedback by LTE rank 1 codebook of 2 TX. The rank number (N_{L}) and the number of either transmitting antennas or receiving antennas (N_{A}) are not limited to the present invention. Of course the kind of a precoding matrix is not limited to the present invention.

As described above, those skilled in the art will appreciate that various modifications, additions and substitutions are possible, without departing from the scope and spirit of the invention as disclosed in the accompanying claims. Therefore, it should be understood that the above-described embodiments are not limiting, but are only exemplary. The scope of the present invention is defined by the accompanying claims rather than the detailed description. All changes or modifications that can be derived from the meaning and scope of the claims and equivalent concepts thereof should be interpreted as being included in the scope of the present invention.

1. A method for feedbacking channel information for the mobile terminal, the method comprising:
estimating a downlink channel from the received signal;
selecting one matrix in the codebook based on the estimated channel state information wherein the codebook has the property to support differential PMI feedback; and
feedbacking the differential value of the PMI (Precoding Matrix Index) of the selected matrix and the previous feedback PMI to the base station.

2. The method in claim 1, wherein the property to support differential PMI feedback is what the matrices in the codebook with the nearest index has the smallest distance.

3. The method in claim 1, wherein the property to support differential PMI feedback is what the matrices in the codebook with the nearest index has the same distance.

4. The method in claim 1, wherein the property to support differential PMI feedback is what the matrix with the largest index has the smallest distance with the matrix with smallest index.

5. The method in claim 1, wherein the codebook to have the property to support differential PMI feedback is DFT codebook.

6. The method in claim 1, wherein the codebook to have the property to support differential PMI feedback is an index reordered codebook from the original codebook which does not have the property to support differential PMI feedback.

7. The method in claim 1, wherein the selecting one matrix comprises: computing the channel state information for all matrices in the codebook; and selecting the matrix which has the highest sum rate or SINR.

8. The method in claim 1, wherein the selecting one matrix comprises: computing the distance between the channel and all matrices in the codebook; and selecting the matrix which is most similar to the channel matrix.

9. A method for feedbacking channel information for the mobile terminal, the method comprising:
estimating a downlink channel from the received signal;
selecting one matrix in the codebook based on the estimated channel state information;
checking whether it is in differential PMI (Precoding Matrix Index) feedback mode;
feedbacking the differential value of the PMI of the selected matrix and the previous feedback PMI to the base station if it is in differential PMI feedback mode (Y); and
feedbacking this PMI to the base station If it is not in differential PMI feedback mode (N).

10. The method in claim 9, wherein the selecting one matrix comprises: computing the channel state information for all matrices in the codebook; and selecting the matrix which has the highest sum rate or SINR.

11. The method in claim 10, wherein the selecting one matrix comprises: computing the distance between the channel and all matrices in the codebook; and selecting the matrix which is most similar to the channel matrix.

12. The method in claim 10, wherein the checking is decided by taking at least one of the following factors into account:
1) For the first feedback, it can not be in the differential PMI feedback mode.
2) For high mobility or performance requirement, it is better to feedback this PMI.
3) Periodically the feedbacking this PMI is used to remove the accumulated error by feedbacking the differential value.

13. The method in claim 9, wherein the codebook has the property where the matrices in the original codebook with the nearest index has the smallest distance.

14. The method in claim 9, wherein the codebook has the property where the matrix with the largest index has the smallest distance with the matrix with smallest index.

15. The method in claim 9, wherein the codebook is an index reordered codebook from the original codebook which does not have the property to support differential PMI feedback.

16. A codebook for selecting one matrix and feedbacking channel information to the base station by the mobile terminal, the codebook comprising: the property where the matrices in the codebook with the nearest index has the smallest distance and where the matrix with the largest index has the smallest distance with the matrix with smallest index.

17. The codebook in claim 16, wherein the property supports differential PMI (Precoding Matrix Index) feedback which feedbacks the differential value of the PMI of the selected matrix and the previous feedback PMI to the base station.

18. The codebook in claim 17, wherein the codebook is an index reordered codebook from the original codebook which does not have the property to support differential PMI feedback.

19. A mobile terminal comprising:
An estimator configured to estimate a downlink channel from a received signal, select one matrix in the codebook based on the estimated channel state information,
check whether it is in differential PMI (Precoding Matrix Index) feedback mode, feedbacking the differential value of the PMI of the selected matrix and the previous feedback PMI to the base station if it is in differential PMI feedback mode (Y) and feedback this PMI to the base station If it is not in differential PMI feedback mode (N); and
a post-decoder configured to process the received signal and decode the precoded symbol.

20. The mobile terminal in claim 19, wherein the estimator is configured to compute the channel state information for all matrices in the codebook and select the matrix which has the highest sum rate or SINR.

21. The mobile terminal in claim 19, wherein the estimator is configured to compute the distance between the channel and all matrices in the codebook and select the matrix which is most similar to the channel matrix.

22. The mobile terminal in claim 19, wherein the estimator checks whether it is in differential PMI (Precoding Matrix Index) feedback mode by taking at least one of the following factors into account:
1) For the first feedback, it can not be in the differential PMI feedback mode.
2) For high mobility or performance requirement, it is better to feedback this PMI.
3) Periodically the feedbacking this PMI is used to remove the accumulated error by feedbacking the differential value.

23. The mobile terminal in claim 19, wherein the codebook has the property where the matrices in the codebook with the nearest index have the smallest distance.

24. The method in claim 19, wherein the codebook has the property where the matrix with the largest index has the smallest distance with the matrix with smallest index.

25. The method in claim 19, wherein the codebook is an index reordered codebook from the codebook which does not have the property to support differential PMI feedback.

26. A base station comprising:
a layer mapper configured to map one or two codewords to the layers;
a precoder configured to receive the differential value of the PMI compared with previous feedback PMI and add the differential PMI to the previous feedback PMI to get the updated PMI, and precode the symbols from the layer mapper using a precoding matrix derived from the updated PMI.

27. The base station in claim 26, wherein the precoder uses this matrix corresponding to the updated PMI as the precoding matrix.

28. The base station in claim 26, wherein the precoder takes this matrix corresponding to the updated PMI as the channel matrix to derive the precoding matrix.
